(19) United States
(12) Patent Application Publication
(10) Pub. No.: US 2012/0314138 A1
(43) Pub. Date: Dec. 13, 2012

(54) LIGHTING DEVICE, DISPLAY DEVICE AND TELEVISION RECEIVER

(75) Inventor: Yoshiki Takata, Osaka-shi (JP)

(73) Assignee: SHARP KABUSHIKI KAISHA, Osaka-shi, Osaka (JP)

(21) Appl. No.: 13/578,822

(22) PCT Filed: Jan. 24, 2011
(86) PCT No.: PCT/JP2011/051177

§ 371 Date: Aug. 14, 2012

(30) Foreign Application Priority Data
Feb. 26, 2010 (JP) 2010-041989

(51) Int. Cl. H04N 5/44; G02F 1/13357; F21V 13/02

(52) U.S. Cl. 348/725; 362/609; 349/65; 348/E07.001

(57) ABSTRACT

A lighting device configured to suppress the formation of a dark spot on a light incidence surface of a light guide plate is provided. A lighting device according to the invention includes a light source 17, a light guide plate 19, and an optical path altering member 34. The light guide plate 19 has a light incidence surface 19b on a side face thereof. The optical path altering member 34 is arranged so as to cover a light emission surface 17a of the light source 17. The light source 17 is disposed so as to face the light incidence surface 19b of the light guide plate 19 with the optical path altering member 34 therebetween. The optical path altering member 34 reflects or refracts the light from the light source 17, and therefore the light exits in a direction toward a part 19b2 of the light incidence surface 19b that does not directly face the light source 17.

### TECHNICAL FIELD

The present invention relates to a lighting device, a display device, and a television receiver.

### BACKGROUND ART

Since a liquid crystal panel used for a liquid crystal display device such as a liquid crystal television set does not emit light by itself, a backlight unit is additionally necessary as a lighting device. One of known backlight units is an edge light type device installed on a rear side of a liquid crystal panel (opposite to a display plane). In general, an edge light type device includes a light source (for example, LED) disposed at a periphery of a backlight unit and a light guide plate. Light from the light source enters the light guide plate through a light incidence surface thereof and exits toward a display plane of a liquid crystal panel.

In the above backlight unit, light easily enters a part of the light incidence surface of the light guide plate that faces the light source. However, light is difficult to enter a part thereof that faces a portion where the light source is not disposed (for example, a portion between adjacent light sources). As a result, the brightness is lower in the part of the light guide plate which the light from the light source is difficult to enter than in the circumference, and in some cases, a locally dark area might be formed. As a device configured to suppress the formation of a dark spot on the light guide plate, a device described in Patent Document 1 has been known. This device includes a trapezoidal extension part formed on one side surface of the light guide plate that faces the light source. The light emitted from the light source is reflected by the trapezoidal extension part, thereby reducing the dark spot on the light guide plate.
Patent Document 1: Japanese Unexamined Patent Publication No. 2004-87408

### Problem to be Solved by the Invention

However, the device disclosed in Patent Document 1 has a structure in which light is propagated in the light guide plate using the light reflection characteristic of the trapezoidal extension part. Accordingly, this device requires correct alignment of the relative position between the light source and the trapezoidal extension part. This causes difficulty in production. Moreover, although the device disclosed in Patent Document 1 can reduce the dark spot on the light guide plate, the device does not allow the light entering the entire light incidence surface of the light guide plate to have uniform brightness. Therefore, there is still room for improvement.

### DISCLOSURE OF THE PRESENT INVENTION

The present invention has been made in view of the foregoing circumstances. It is an object of the present invention to provide a lighting device configured to suppress the formation of a dark spot on a light incidence surface of a light guide plate. It is another object of the present invention to provide a display device including the lighting device and to further provide a television receiver including the display device.

### Means for Solving the Problem

A lighting device according to the present invention made for achieving the above object includes a light source having an emission surface, a light guide plate having a light incidence surface on a side face thereof through which light emitted from the light source enters, and an optical path altering member arranged to cover the light emission surface of the light source. The light guide plate is configured to guide the light entered therein. The optical path altering member is configured to alter an optical path of the light emitted from the light source. The light source is arranged so as to face the light incidence surface of the light guide plate with the optical path altering member therebetween. The optical path altering member reflects or refracts the light emitted from the light source such that the light travels toward a part of the light incidence surface that does not face the front of the light source.

In the case where light emitted from a light source, especially a light source with high emission directivity such as an LED, directly enters the light incidence surface of the light guide plate, a part of the light incidence surface that faces the front of the light source receives much light but a part thereof that does not face the front of the light source (for example, the part that faces a space between adjacent light sources) is difficult to receive light and in some cases, a dark sport might be formed at which the brightness is lower than in the circumference. However, according to the structure of the present invention, the light emitted from the light source is directed toward the part of the light incidence surface of the light guide plate that does not face the front of the light source because the optical path altering member covering the light source reflects or refracts the light to alter the optical path of the light. As a result, a sufficient amount of light enters even the part of the light incidence surface that does not face the front of the light source, and thus, the formation of the dark spot on that part can be suppressed.

The optical path altering member may include a reflection part provided intersecting with the light emission surface of the light source and reflecting the light from the light source, and an light exiting part through which the light reflected on the reflection part exits.

This structure can alter the optical path of the light emitted straightly upward from the light emission surface of the light source in a direction other than the straightly upward direction by reflection of the light on the reflection part provided intersecting with the light emission surface, and allows easy optical design because the emission direction of light having passed through the optical path altering member can be determined to be any direction by setting the light exiting part at any position.

The light exiting part may be disposed substantially perpendicular to the light incidence surface of the light guide plate.

With this structure, the light exiting from the light exiting part travels in a direction different from the direction substantially perpendicular to the light incidence surface, for example, travels in a direction substantially parallel to the light incidence surface. Accordingly, light easily reaches the part of the light incidence surface that does not face the front of the light source, more specifically, the part of the light incidence surface that is relatively away from the light source, which makes it possible to suppress the formation of the dark spot.

The light source may include a plurality of light sources. In this case, the optical path altering member covering a light emission surface of a first light source may have its light exiting part facing another light source that is adjacent to the first light source.

In this structure, light exiting from the light exiting part of the optical path altering member travels from the first light source toward the other light source adjacent thereto. Therefore, light spreads even to the space between the adjacent light sources to allow the light to reach the part of the light incidence surface that does not face the front of the light source, especially the part thereof that faces the space between the light sources where the dark spot is easily formed. As a result, the formation of the dark spot on the light guide plate can be suppressed further.

The light source may include a plurality of light sources. In this case, the optical path altering member provided for a first light source among the light sources may have its reflection part on another light source side that is adjacent to one side of the first light source and have its light exiting part on another light source side that is adjacent to the other side of the first light source.

This structure allows easy optical design because the emission direction of the light emitted via the optical path altering member is limited to a predetermined direction (one direction in which the light exiting part is disposed).

The optical path altering member may have a substantially right triangular section whose hypotenuse part serves as the reflection part and whose leg part rising from the light source side to the light guide plate side serves as the light exiting part.

This simple structure can suppress the formation of the dark spot on the light guide plate at low cost because the light from the light source can be emitted after its optical path is altered by the optical path altering member.

A first reflection member that faces the light incidence surface may be disposed on a surface of the reflection part that is opposite to a surface thereof facing the light source.

This structure allows the efficient use of the light from the light source because the light emitted from, for example, another light source can be reflected on the first reflection member toward the light incidence surface of the light guide plate. Meanwhile, covering the light source with the optical path altering member might lead to the formation of a dark spot on the part of the light incidence surface of the light guide plate that faces the front of the light source. However, according to the above structure, the light reflected on the first reflection member reaches the part of the light incidence surface that faces the light source, and thus, the formation of the dark spot on the light guide plate can be suppressed further.

The optical path altering member may have a concave part depressed toward the light source at the part of the optical path altering member that faces the light incidence surface and that overlaps with the light source in a plan view. The concave part may refract and emit the light from the light source outward from the center of the depression.

In this structure, the light emitted from the light source travels not straightly upward from the light source but travels to spread toward the periphery of the light source because the optical path is altered by the concave part. Accordingly, the light emitted from the light source can be directed toward the part of the light incidence surface of the light guide plate that does not face the front of the light source. As a result, a sufficient amount of light can enter the part of the light incidence surface that does not face the front of the light source, and the formation of the dark spot on that part can be suppressed.

The optical path altering member may have, in the part thereof that faces the light source, a light incidence part that is depressed toward the light guide plate and that refracts the light incoming from the light source outward from the center of the depression.

This structure can increase the directivity of the emission light toward the part of the light incidence surface of the light guide plate that does not face the front of the light source because the light incidence part can make the light incoming from the light source travel more widely to the periphery of the light source.

The optical path altering member may have, around the concave part in the part of the optical path altering member that faces the light incidence surface, a curved part curved in an arc-like manner.

This structure allows the emission light to travel in a wide range in accordance with the curved shape of the curved part. As a result, the light can enter the entire light incidence surface of the light guide plate, and therefore the formation of the dark spot on the light incidence surface can be suppressed further.

Moreover, the light source may include a plurality of light sources. In this case, the optical path altering member may cover each of the light sources individually.

In this structure, the emission direction can be controlled for each light source and the optical design is easy.

A light source board on which the light source is mounted may be provided. A second reflection member that faces the light incidence surface of the light guide plate may be disposed on a surface of the light source board that includes the light source.

Moreover, a chassis housing the light source and the optical path altering member may be provided. A third reflection member that faces the light incidence surface of the light guide plate may be disposed on a surface of the chassis that includes the light source.

This structure allows the efficient use of the light from the light source, higher brightness, or reduction in number of light sources because the light emitted from the light source or the light reflected on the peripheral member can be guided to the light guide plate by being reflected on the second reflection member and/or the third reflection member.

An LED may be used as the light source.

The use of an LED leads to longer life and lower power consumption of the light source. In particular, since an LED has high emission directivity, there is a high tendency that a sufficient amount of light reaches the part of the light incidence surface of the light guide plate that faces the front of the LED but not much light reaches the part thereof that does not face the front of the LED. As a result, when an LED is used as the light source, the structure of the present invention that allows light with substantially uniform brightness to enter the entire light incidence surface of the light guide plate is more effective.

Next, a display device according to the present invention made for achieving the above object includes the aforementioned lighting device and a display panel performing display with light from the lighting device.

Such a display device can achieve excellent display with display unevenness suppressed even in the display device because illumination light with substantially uniform brightness can be obtained as a whole without the formation of the dark spot in the lighting device.

An example of the display panel is a liquid crystal panel. The display device is suitable for the use as a liquid crystal display device in various applications such as a TV set, a display for a personal computer, or the like especially with a large screen.

A television receiver according to the present invention includes the display device.

The television receiver can provide a highly visible device with no display unevenness.

### Advantageous Effect of the Invention

According to the lighting device of the present invention, the dark spot is difficult to be formed on the light guide plate and illumination light with substantially uniform brightness can be obtained as a whole. Moreover, since the display device of the present invention includes such a lighting device, excellent display with display unevenness suppressed is possible. Furthermore, since the television receiver of the present invention includes such a display device, the television receiver is highly visible and has no display unevenness.

### BRIEF DESCRIPTION OF THE DRAWINGS

FIG. 1 is an exploded perspective view of a schematic structure of a television receiver according to a first embodiment of the present invention;

FIG. 2 is an exploded perspective view of a schematic structure of a liquid crystal display device included in the television receiver;

FIG. 3 is a sectional view of a structure taken along a longitudinal direction of the liquid crystal display device;

FIG. 4 is a sectional view of a structure taken along a latitude direction of the liquid crystal display device;

FIG. 5 is a schematic plan view of a structure of a backlight unit;

FIG. 6 is a schematic perspective view of a structure of an LED unit;

FIG. 7 is a schematic plan view of a different structure of the backlight unit;

FIG. 8 is a schematic plan view of a structure of a backlight unit according to a second embodiment of the present invention;

FIG. 9 is a magnified sectional view of a main part of the LED unit;

FIG. 10 is a magnified plan view of the main part of the LED unit;

FIG. 11 is a graph of brightness distribution of light emitted via a light guide lens;

FIG. 12 is a schematic side view of a different structure of the backlight unit;

FIG. 13 is a top view of an LED unit included in the backlight unit of FIG. 12;

FIG. 14 is a schematic plan view of a structure of a backlight unit according to a third embodiment of the present invention;

FIG. 15 is an exploded perspective view of a schematic structure of a liquid crystal display device according to a fourth embodiment of the present invention; and

FIG. 16 is a sectional view of a structure of the liquid crystal display device of FIG. 15.

### BEST MODE FOR CARRYING OUT THE INVENTION

### First Embodiment

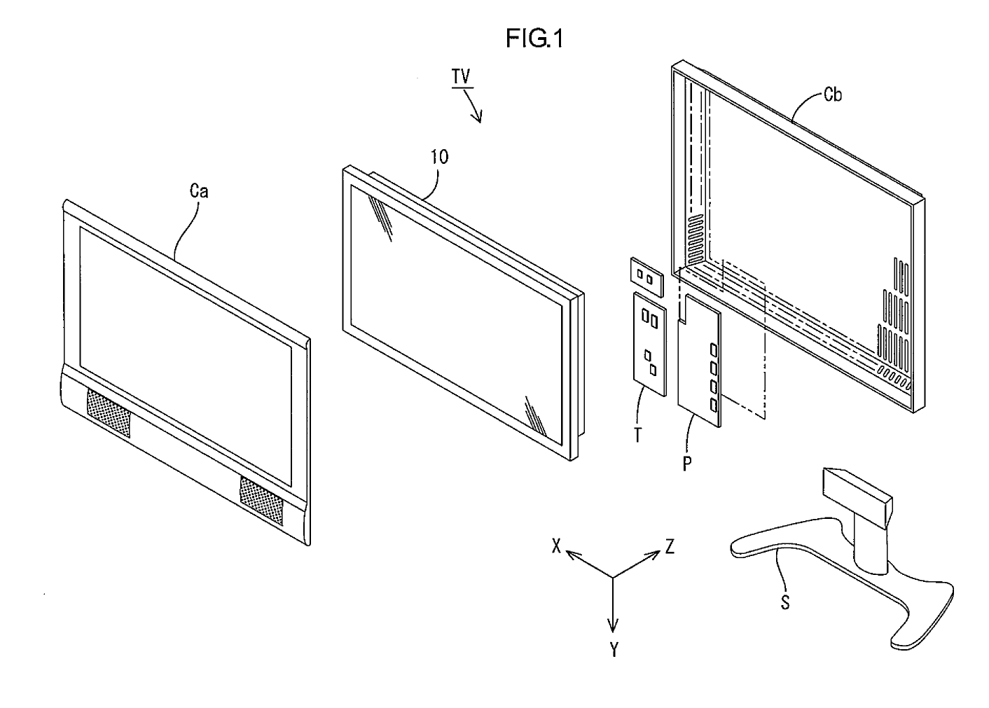

A first embodiment of the present invention is described with reference to FIG. 1 to FIG. 6. Note that X-axis, Y-axis, and Z-axis are described in some of the drawings, whose directions are in common in the drawings. The Y-axis direction coincides with the vertical direction and the X-axis direction coincides with the horizontal direction. Unless otherwise specified, upper and lower directions are based on the vertical direction.

First, a structure of a television receiver TV including a liquid crystal display device 10 is described.

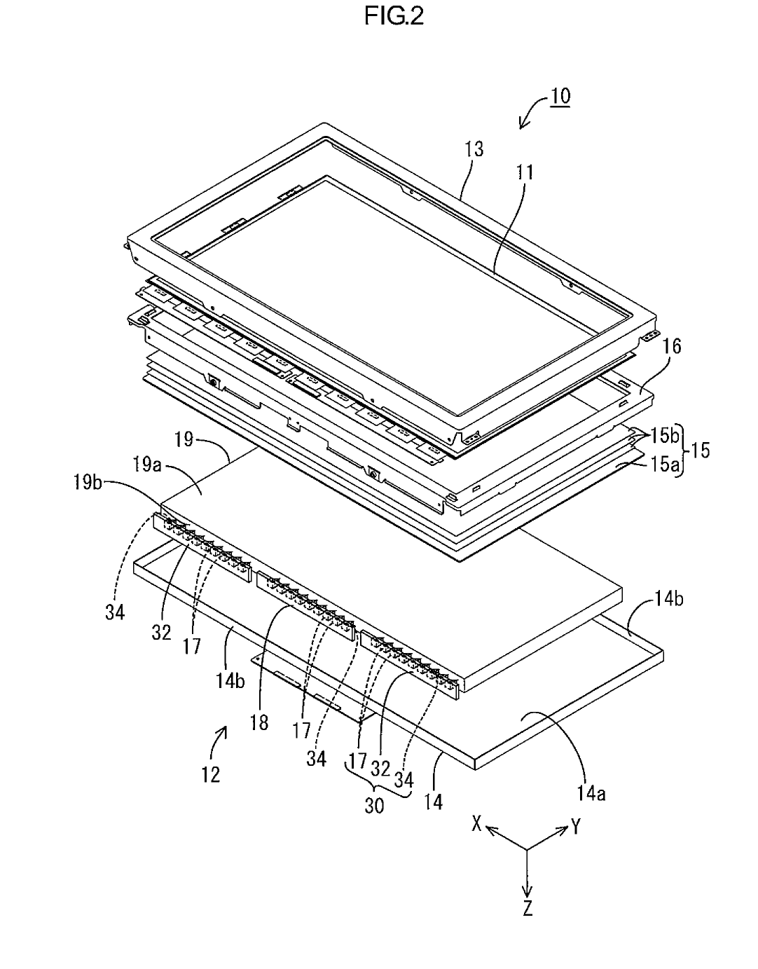

The television receiver TV according to this embodiment includes, as illustrated in FIG. 1, the liquid crystal display device 10, front and rear cabinets Ca and Cb housing the liquid crystal display device 10 so as to have the liquid crystal display device 10 therebetween, a power source P, a tuner T, and a stand S. The liquid crystal display device (display device) 10 has a horizontally long rectangular shape as a whole, and is housed in a vertically installed state. This liquid crystal display device 10 includes a liquid crystal panel 11 as a display panel, and a backlight unit (lighting device) 12 as an external light source as illustrated in FIG. 2. They are held integrally by a frame-shaped bezel 13 and the like.

Next, the liquid crystal panel 11 and the backlight unit 12 included in the liquid crystal display device 10 are described (see FIG. 2 to FIG. 4).

The liquid crystal panel (display panel) 11 has a structure in which a pair of glass substrates is attached to each other with a predetermined gap and liquid crystal is enclosed between the glass substrates. On one glass substrate, a switching component (such as a TFT) connected to a source line and a gate line intersecting with each other, a pixel electrode connected to the switching component, an alignment film, and the like are provided. On the other glass substrate, a color filter in which color sections for R (red), G (green), B (blue), and the like are arranged in predetermined formation, a counter electrode, an alignment film, and the like are provided. Furthermore, a polarizing plate is disposed outside the both substrates.

The backlight unit 12 includes, as illustrated in FIG. 2, a chassis 14 with an approximately box-like shape that has an opening opened toward the light emission surface side (liquid crystal panel 11 side), an optical sheet group 15 (a diffuser plate 15a and a plurality of optical sheets 15b disposed between the diffuser plate 15a and the liquid crystal panel 11) disposed covering the opening of the chassis 14, and a frame 16 disposed along an outer periphery of the chassis 14 and holding an outer periphery of the diffuser plate 15a by having the outer periphery of the diffuser plate 15a between the frame 16 and the chassis 14. Moreover, the chassis 14 includes an LED unit 30 including an LED 17 (Light Emitting Diode) as a light source, a light guide plate 19 guiding the light emitted from the LED unit 30 to the optical sheet group 15 (liquid crystal panel 11), and the frame 16 pressing the light guide plate 19 from the front side. The backlight unit 12 is of so-referred to as edge light type (side light type) having the LED unit 30 at an end in its longitudinal direction and the light guide plate 19 in the center. Each component of the backlight unit 12 will be specifically described below. The light emission side of the back light device 12 is the diffuser plate 15a side rather than the LED unit 30.

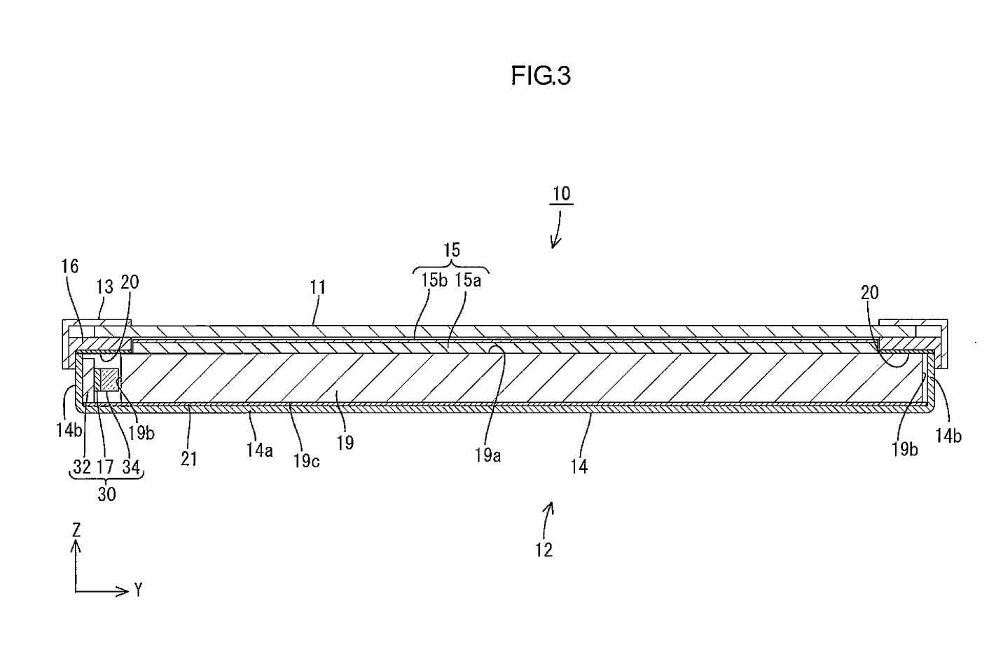

The chassis 14 is made of metal such as an aluminum material. The chassis 14 includes a bottom plate 14a with a horizontally long rectangular shape like the liquid crystal panel 11, and a pair of side plates 14b that rise from the both outer ends of the bottom plate 14a in the longitudinal direction as illustrated in FIG. 2 and FIG. 3. The longitudinal direction of the chassis 14 (bottom plate 14a) coincides with the X-axis direction (horizontal direction) and the latitude direction thereof coincides with the Y-axis direction (vertical direction). The side plate 14b allows screw clamp with the frame 16 and the bezel 13.

The optical sheet group 15 including the diffuser plate 15a and the optical sheets 15b is provided on the opening side of the chassis 14. The diffuser plate 15a is formed by dispersion and mixture of optically scattered particles on a plate-like member made of a synthetic resin, and has a function of diffusing dot-like light emitted from the LED 17 serving as a dot-like light source. The outer periphery of the diffuser plate 15a is mounted on a reception plate 14c of the chassis 14 as described above, and is not affected by a vertical firm binding force.

The optical sheets 15b on the diffuser plate 15a each have a sheet-like shape that is thinner than the diffuser plate 15a. Three optical sheets 15b are laminated on each other. Specific examples of the optical sheet 15b include a diffuser sheet, a lens sheet, and a reflection-type polarizing sheet, and an appropriate sheet is selected from these. The optical sheets 15b have a function of making the light emitted from the LED 17 and transmitted through the diffuser plate 15a planar light. The liquid crystal panel 11 is disposed on the top face side of the optical sheets 15b.

The frame 16 is formed in a frame-like form (like a picture frame) extending along the outer periphery of the light guide plate 19 as illustrated in FIG. 2, and can press almost the entire outer periphery of the light guide plate 19 from the front side. This frame 16 is made of a synthetic resin, and has a light-blocking property by having a black surface, for example. On a rear surface of the frame 16 in the both longitudinal parts, that is, the surface that faces the light guide plate 19 and the LED unit 30, a front-side reflection sheet 20 reflecting light is attached as illustrated in FIG. 3. The front-side reflection sheet 20 has a size that extends along almost the entire length of the longitudinal part of the frame 16, is in direct contact with the end of the light guide plate 19 on the LED 17 side, and covers the end of the light guide plate 19 and the LED unit 30 together from the front side. Moreover, the frame 16 can receive the outer periphery of the liquid crystal panel 11 from the rear side.

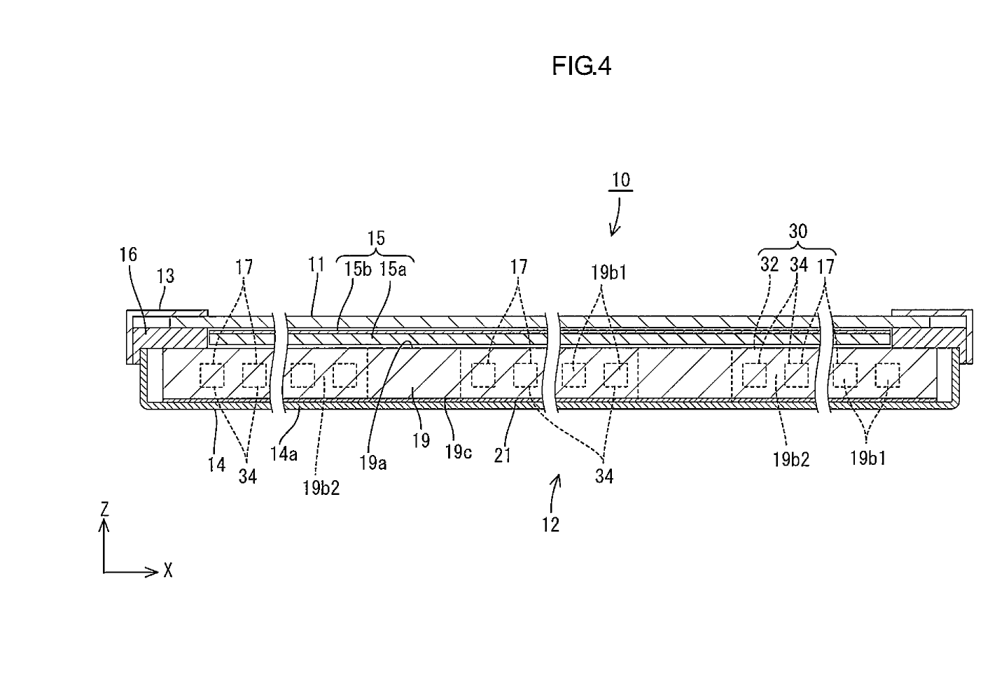

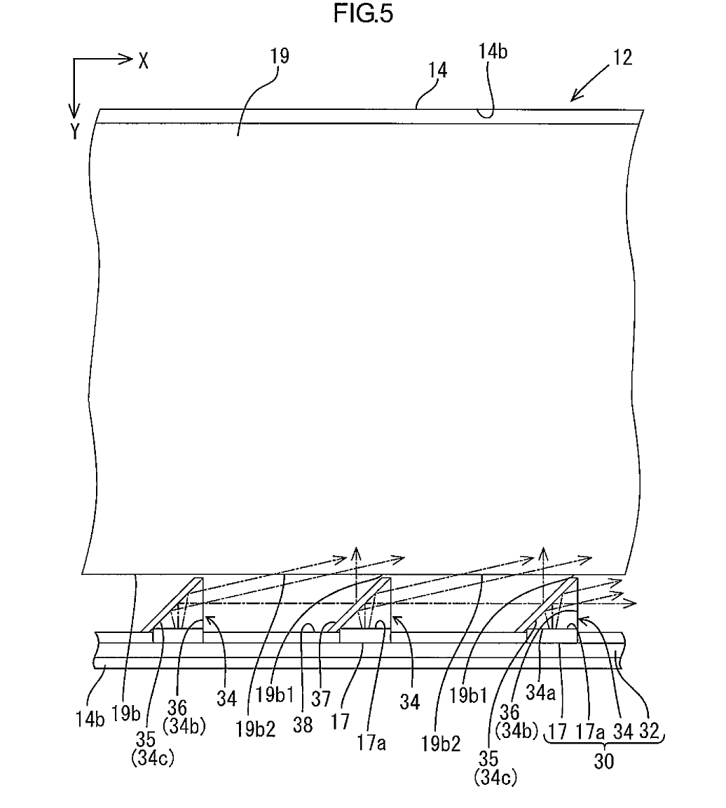

The light guide plate 19 is made of a synthetic resin material (such as acrylic) that is substantially transparent (highly light transmissive) and that has a much higher refractive index than the air. As shown in FIG. 2, the light guide plate 19 has a substantially flat plate member with a rectangular shape in a plan view extending along the bottom plate 14a of the chassis 14 and each plate surface of the optical sheet group 15, and the main plate surfaces are in parallel in the X-axis direction and the Y-axis direction. One of the main plate surfaces of the light guide plate 19 that faces the front side (surface that faces the optical sheet group 15) serves as an emission surface 19a that emits light, which has propagated inside the light guide plate 19, toward the optical sheet group 15 and the liquid crystal panel 11. Moreover, one of the longitudinal side plate surfaces of the light guide plate 19 faces the LED unit 30 with a predetermined space therebetween, and the one side plate surface serves as a light incidence surface 19b receiving the light emitted from the LED 17. The light incidence surface 19b is a surface which is in parallel to the X-axis direction and the Z-axis direction (existing in the X-Z plane) and which is substantially orthogonal to the emission surface 19a. The light incidence surface 19b has a part 19b1 that faces the front of the LED 17 and a part 19b2 that does not face the front of the LED 17 (see FIG. 4 and FIG. 5). The parts 19b1 and 19b2 are specifically described later. The light guide plate 19 guides the light emitted from the LED 17 in the Y-axis direction through the light incidence surface 19b, and makes the light propagate inside and rise toward the optical sheet group 15 (Z-axis direction), and therefore the light is emitted from the emission surface 19a.

On a surface 19c of the light guide plate 19 that is opposite to the emission surface 19a, a rear-side reflection sheet 21 that reflects the light in the light guide plate 19 to make the light rise to the front side is disposed. The rear-side reflection sheet 21 extends so as to overlap with the LED unit 30 (LED 17) in a plan view (see FIG. 3). The LED unit 30 (LED 17) is sandwiched between the rear-side reflection sheet 21 and the front-side reflection sheet 20. This allows the efficient light incidence into the light incidence surface 19b because the light from the LED 17 is repeatedly reflected between the both reflection sheets 20 and 21. On at least one of the emission surface 19a and its opposite surface 19c of the light guide plate 19, a reflection part (not illustrated) reflecting the internal light or a scattering part (not illustrated) scattering the internal light is patterned to have predetermined in-plane distribution, and therefore the emission light from the emission surface 19a is controlled to have uniform in-plane distribution.

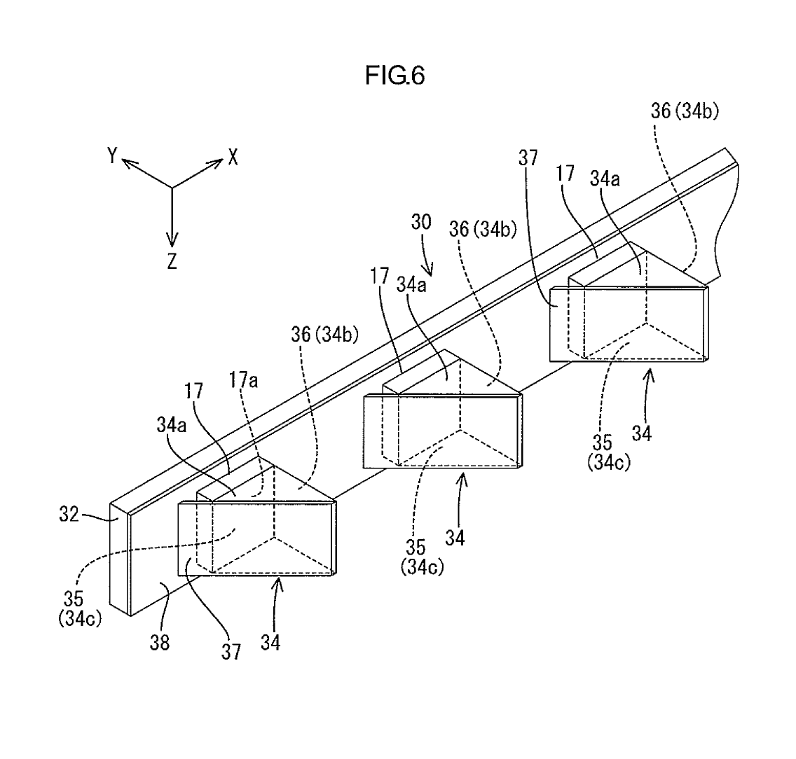

Subsequently, a structure of the LED unit 30 is described specifically. FIG. 5 is a schematic plan view of a structure of the backlight unit, and FIG. 6 is a perspective view of a structure of the LED unit. In FIG. 5, only the chassis 14, the light guide plate 19, and the LED unit 30 are illustrated and the other members are not illustrated. Dashed lines in FIG. 5 represent the optical paths of light emitted from the LED unit 30.

As shown in FIGS. 5 and 6, the LED unit 30 includes the LEDs 17 that emit white light along a line on a rectangular LED board 32 made of resin. The LEDs 17 are arranged at predetermined intervals. A light guide body (optical path altering member) 34 is provided so as to cover a light emission surface 17a of each LED 17. The LED unit 30 is attached to one side plate 14b of the chassis 14 with a screw or the like such that the light incidence surface 19b of the light guide plate 19 faces the LED 17 with the light guide body 34 therebetween. The light guide bodies 34 are arranged so as to cover each of the LEDs 17. The light guide body 34 is made of acrylic, and has a triangular prism shape as a whole. The light guide body 34 has a substantially isosceles right triangular section including a bottom part 34a which is in parallel to the light emission surface 17a of the LED 17, a leg part 34b rising substantially vertically from one end of the bottom part 34a (rising substantially vertically from the LED 17 side toward the light guide plate 19), and a hypotenuse part 34c connecting the other end of the bottom part 34a and the risen edge of the leg part 34b (see FIG. 5). The hypotenuse part 34c intersects with the light emission surface 17a of the LED 17, and serves as a reflection part 35 reflecting the light emitted from the LED 17. Since the reflection part 35 is the hypotenuse part 34c of the substantially isosceles right triangle, the reflection part 35 is tilted to the light emission surface 17a by about 45 degrees. Here, the LED 17 has high emission directivity in the direction perpendicular to the light emission surface 17a (Y-axis direction). On the other hand, since acrylic constituting the light guide body 34 has a critical angle ranging from 41 to 42 degrees, the light emitted from the light emission surface 17a in the Y-axis direction reaches the reflection part 35 at an angle larger than the critical angle and is reflected almost totally on the reflection part 35. Thus, the optical path thereof is altered. The light reflected on the reflection part 35 is guided in the light guide body 34 and reaches the leg part 34b.

The leg part 34b serves as an light exiting part 36 through which the guided light exits. The light exiting part 36 is in parallel to the Y-axis direction and the Z-axis direction and is substantially perpendicular to the light incidence surface 19b of the light guide plate 19. Therefore, the light exiting from the light exiting part 36 travels in a direction different from the Y-axis direction (in a direction straightly upward from the LED 17), for example, in substantially the X-axis direction (direction substantially parallel to the light incidence surface 19b of the light guide plate 19). In other words, most of the light exiting from the light exiting part 36 does not travel toward the part 19b1 of the light incidence surface 19b that faces the front of the LED 17 but is directed to the part 19b2 of the light incidence surface 19b that does not face the front of the LED 17. This light exiting part 36 faces a second LED 17 side that is adjacent to a first LED 17 among the plurality of LEDs 17. More specifically, the light guide body 34 has the reflection part 35 provided on the second LED 17 (left LED 17 in FIG. 5) side that is adjacent to one side of the first LED 17 (central LED 17 in FIG. 5) and has the light exiting part 36 on the second LED 17 (right LED 17 in FIG. 5) side that is adjacent to the other side of the first LED 17. Therefore, the light exiting from the light guide body 34 does not travel toward the left LED 17 in FIG. 5 but travels toward the right LED 17 in FIG. 5, and enters the part 19b2 of the light incidence surface 19b of the light guide plate 19 that does not directly face the LED 17 (the part facing the space between the adjacent LEDs 17).

On a surface of the reflection part 35 opposite to a surface thereof that faces the LED 17, a first reflection sheet (first reflection member) 37 is disposed. The first reflection sheet 37 covers the entire surface of the reflection part 35 opposite to the surface thereof that faces the LED 17, and extends to a second reflection sheet 38, which is described later, without any space between the first reflection sheet 37 and the second reflection sheet 38. This first reflection sheet 37 is disposed to face the light incidence surface 19b of the light guide plate 19. A surface of the first reflection sheet 37 is made of a white synthetic resin with high light reflection property, and therefore the light emitted from the adjacent LED 17 can be reflected toward the light incidence surface 19b of the light guide plate 19.

Moreover, on a surface of the LED board 32 that includes the LED 17 (front-side surface, surface on the light guide plate 19 side), a second reflection sheet (second reflection member) 38 is disposed to face the light incidence surface 19b of the light guide plate 19. A surface of the second reflection sheet 38 is made of a white synthetic resin with high light reflection property, and therefore the light emitted from the light exiting part 36 of the light guide body 34 and the light reflected on the peripheral member (such as the light guide plate 19) can be reflected toward the light incidence surface 19b of the light guide plate 19.

As described thus, in the lighting device including the LED 17, the light guide plate 19, and the light guide body 34 covering the light emission surface 17a of the LED 17 according to this embodiment, the LED 17 is disposed to face the light incidence surface 19b of the light guide plate 19 via the light guide body 34 and the light emitted from the LED 17 is reflected on the light guide body 34. Thus, the light is emitted in a direction toward the part of the light incidence surface 19b that does not face the front of the LED 17. In this structure, the light emitted from the LED 17 is directed toward the part of the light incidence surface 19b of the light guide plate 19 that does not face the front of the LED 17 because the optical path of the light is altered by reflection on the light guide body 34 covering the LED 17. As a result, a sufficient amount of light also enters the part 19b2 of the light incidence surface 19b that does not face the front of the LED 17 and the formation of the dark spot on the part 19b2 can be suppressed.

In this embodiment, the light guide body 34 includes the reflection part 35 provided intersecting with the light emission surface 17a of the LED 17 and reflecting the light from the LED 17, and the light exiting part 36 through which light reflected on the reflection part 35 exits. This structure can alter the optical path of the light emitted straightly upward from the light emission surface 17a of the LED 17 in a direction other than the straightly upward direction by reflection of the light on the reflection part 35 provided intersecting with the light emission surface 19b, and allows easy optical design because the emission direction of the light having passed through the light guide body 34 can be determined to be any direction by setting the light exiting part 36 at any position.

The light exiting part 36 is disposed substantially perpendicular to the light incidence surface 19b of the light guide plate 19. In this structure, the light exiting from the light exiting part 36 travels in a direction different from the direction substantially perpendicular to the light incidence surface 19b (Y-axis direction), such as the direction substantially parallel to the light incidence surface 19b (X-axis direction). This makes the light easily enter the part 19b2 of the light incidence surface 19b that does not face the front of the LED 17, more specifically, the part of the light incidence surface 19b that is relatively away from the LED 17. Thus, the formation of the dark spot can be suppressed.

In the case where the number of the LEDs 17 is plural, the light guide body 34 covering the light emission surface 17a of a first LED 17 among the plurality of LEDs 17 has its light exiting part 36 facing another LED 17 adjacent to the first LED 17. In this structure, the light exiting from the light exiting part 36 of the light guide body 34 travels from the first LED 17 toward the adjacent LED 17. Therefore, light can spread to the space between the adjacent LEDs 17 and 17 to allow the light to reach the part 19b2 of the light incidence surface 19b that does not face the front of the LED 17, especially the part thereof that faces the space between the LEDs 17 and 17 where the dark spot is easily formed. As a result, the formation of the dark spot on the light guide plate 19 can be suppressed further.

In the case where the LEDs 17 are arranged in parallel to each other, the light guide body 34 provided for the first LED 17 has the reflection part 35 on the second LED 17 side that is adjacent to one side of the first LED 17 and has the light exiting part 36 on a third LED 17 side that is adjacent to the other side of the first LED 17. Since this structure limits the emission direction of light emitted via the light guide body 34 to a predetermined direction (one direction in which the light exiting part 36 is provided, on the third LED 17 side), the optical design is easy.

The light guide body 34 has a substantially right triangular section whose hypotenuse part 34c serves as the reflection part 35 and whose leg part 34b rising from the LED 17 side to the light guide plate 19 side serves as the light exiting part 36. This simple structure can suppress the formation of the dark spot on the light guide plate 19 at low cost because the light from the LED 17 can be emitted after its optical path is altered by the light guide body 34.

On the surface of the reflection part 35 opposite to the surface thereof that faces the LED 17, the first reflection sheet 37 that faces the light incidence surface 19b is disposed. This structure allows the efficient use of the light from the LED 17 because the light emitted from another LED 17 can be reflected on the first reflection sheet 37 toward the light incidence surface 19b side of the light guide plate 19. Meanwhile, covering the LED 17 with the light guide body 34 might lead to the formation of a dark spot on the part 19b1 of the light incidence surface 19b of the light guide plate 19 that faces the front of the LED 17. However, according to the above structure, the light reflected on the first reflection member 37 reaches the part 19b1 of the light incidence surface 19b that faces the front of the LED 17, and thus, the formation of the dark spot on the light guide plate 19 can be suppressed further.

The light guide body 34 covers each of the plurality of LEDs 17 individually. In this structure, the emission direction can be controlled for each LED 17 and the optical design is easy.

The LED 17 is mounted on the LED board 32, and on the surface of the LED board 32 that includes the LED 17, the second reflection sheet 38 that faces the light incidence surface 19b of the light guide body 34 is disposed. This structure allows the efficient use of the light from the LED 17, higher brightness, or reduction in number of LEDs 17 because the light emitted from the LED 17 or the light reflected on the peripheral member such as the light guide plate 19 can be guided to the light guide plate 19 by being reflected on the second reflection sheet.

In particular, in this embodiment, the LED 17 is used as the light source. The use of an LED leads to longer life and lower power consumption of the light source, for example. In particular, since the LED 17 has high emission directivity, there is a high tendency that a sufficient amount of light reaches the part 19b1 of the light incidence surface 19b of the light guide plate 19 that faces the front of the LED 17 but not much light reaches the part 19b2 thereof that does not face the front of the LED 17. As a result, when the LED 17 is used as the light source, the light guide body 34 that allows polarization of the optical path of the light from the LED 17 works more effectively.

### Modified Example of First Embodiment

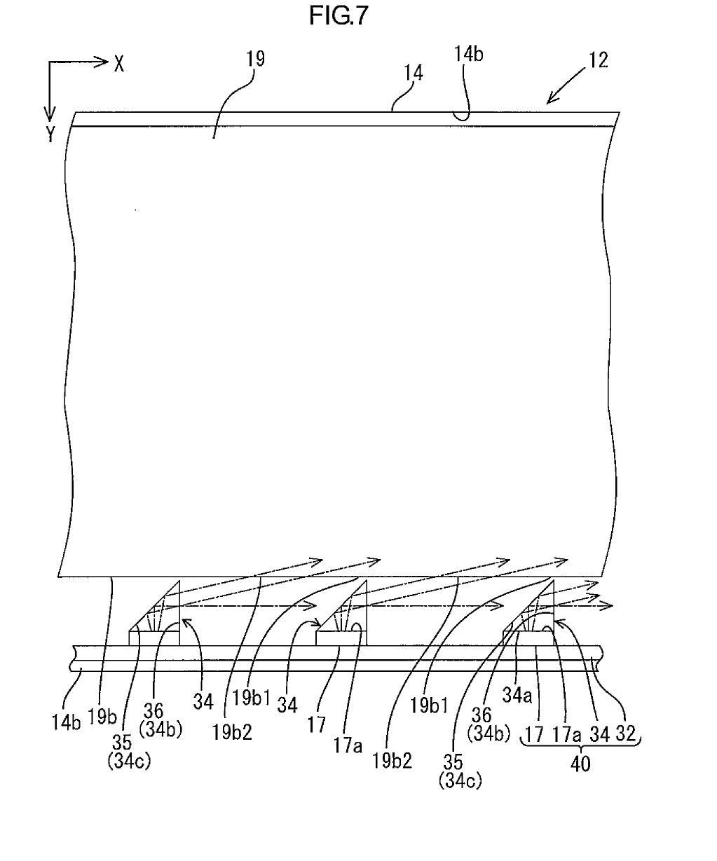

As one modified example of the structure of the LED unit 30, the example illustrated in FIG. 7 can be employed. FIG. 7 is a schematic plan view of a different structure of the backlight unit.

As illustrated in FIG. 7, an LED unit 40 has a structure in which the surface of the reflection part 35 opposite to the surface thereof that faces the LED 17, and the surface of the LED board 32 that includes the LED 17 are exposed. In other words, differently from the structure of the first embodiment, the first reflection sheet 37 and the second reflection sheet 38 are not provided. Even in this structure, the optical path of the light emitted from the LED 17 is altered by reflection on the reflection part 35 of the light guide body 34, and then the light is emitted from the light exiting part 36. Thus, the light is directed toward the part 19b2 of the light incidence surface 19b of the light guide plate 19 that does not face the LED 17. As a result, the formation of the dark spot on the part 19b2 of the light incidence surface 19b can be suppressed.

### Second Embodiment

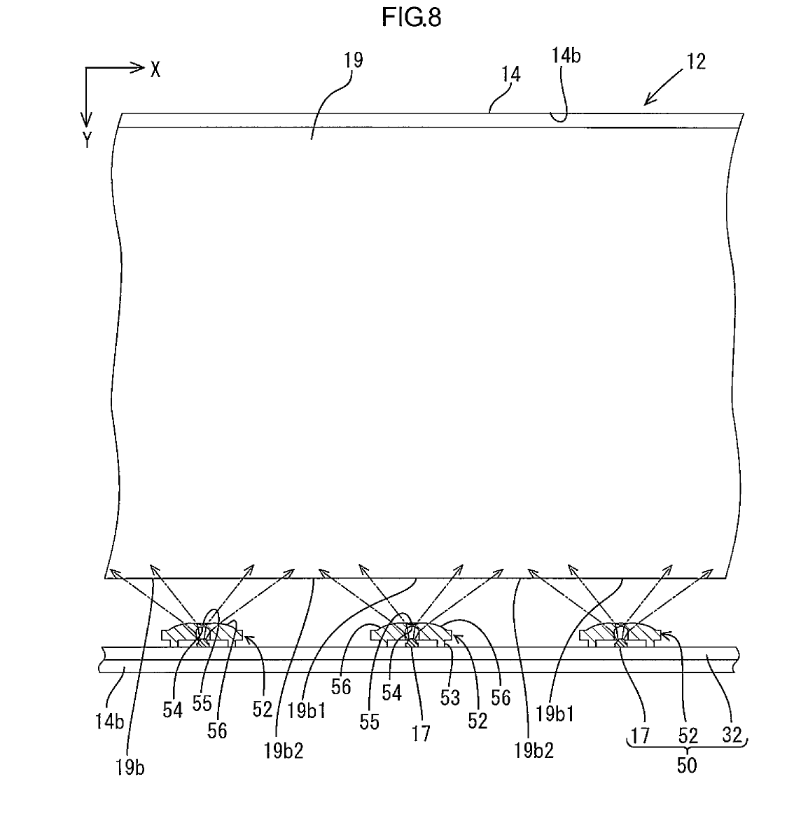

Next, a second embodiment of the present invention is described with reference to FIG. 8 to FIG. 11. The second embodiment employs the LED unit with a modified structure. The same part as that in the first embodiment above is denoted with the same reference symbol and description thereof is omitted.

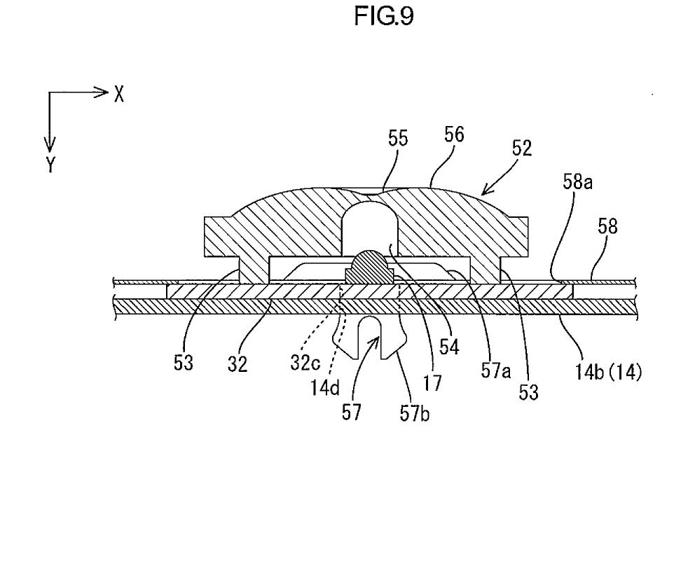

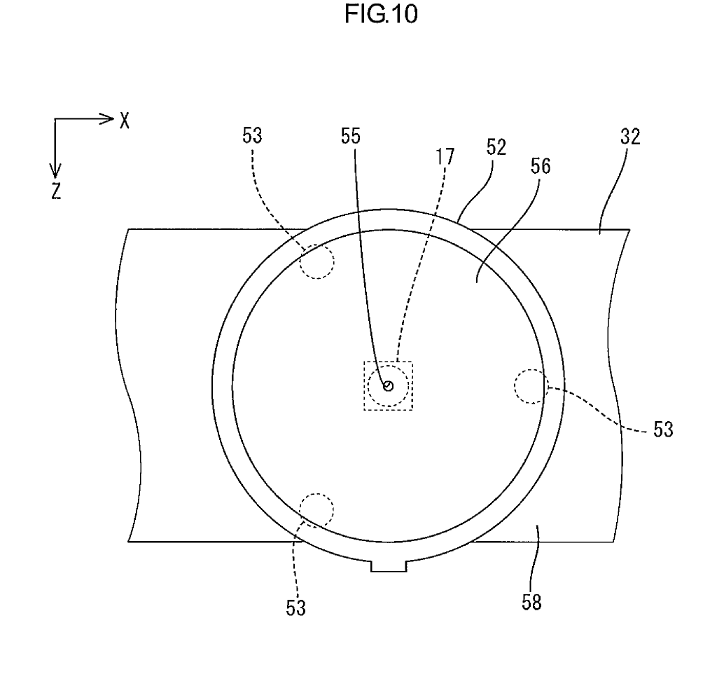

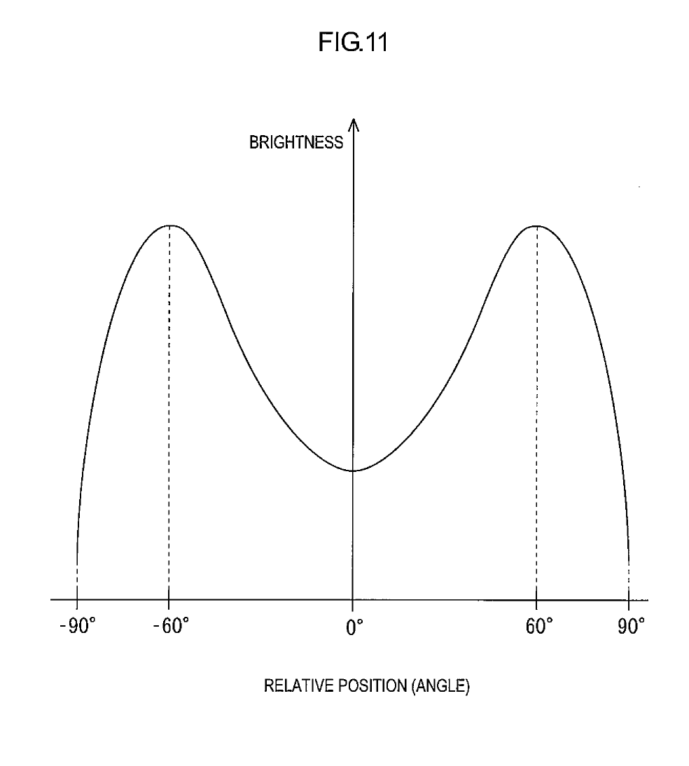

FIG. 8 is a schematic plan view of a structure of a backlight unit according to this embodiment, FIG. 9 is a magnified sectional view of a main part of the structure of the LED unit, FIG. 10 is a magnified plan view of the main part of the structure of the LED unit, and FIG. 11 is a graph of brightness distribution of light emitted via a light guide lens. Note that FIG. 8 illustrates only the chassis 14, the light guide plate 19, and an LED unit 50, and does not illustrate the other members. Dashed lines in FIG. 8 represent the optical paths of light emitted from the LED unit 50.

The LED unit 50 includes, as illustrated in FIG. 8 and FIG. 9, the plurality of LEDs 17 arranged in line on the rectangular LED board 32, and a light guide lens (optical path altering member) 52 with a substantially hemispherical shape covering each of the LEDs 17. The light guide lens 52 is made of a synthetic resin material (such as acrylic) with a much higher refractive index than the air, and is disposed separate from the LED 17 with a space from the LED 17. As illustrated in FIG. 9 and FIG. 10, the light guide lens 52 has three foot parts 53 protruding from a lower peripheral part thereof. The three foot parts 53 are arranged at roughly equal intervals (about 120 degrees) along the periphery of the light guide lens 52. For example, the three foot parts 53 are fixed on the surface of the LED board 32 with an adhesive or a thermally curable resin. A part of the lower surface of the light guide lens 52 (that faces the LED 17), which overlaps with the LED 17 in a plan view, includes an incidence concave part (light incidence part) 54 that is depressed upward (toward the light guide plate 19). The incidence concave part 54 has its side face extending in the Y-axis direction and has its upper surface bending in a convex shape upward (toward the light guide plate 19). The incidence concave part 54 has a function of refracting light, which comes from the LED 17 and enters the side face and the upper surface, outward (in X-axis direction) from the center of the depression, i.e., in a wide angle.

On the other hand, a concave part 55 depressed downward (toward the LED 17 side) is formed in an upper surface of the light guide lens 52, more specifically in the central part of the part that faces the light incidence surface 19b of the light guide plate 19 (part overlapping with the LED 17 in a plan view). The concave part 55 has a gradient mortar shape and a flat substantially-spherical shape whose peripheral surface is gradually sloped downward. Thus, the concave part 55 has a function of refracting and emitting the light, which comes from the incidence concave part 54, outward from the center of the depression. The periphery of the concave part 55 of the upper surface of the light guide lens 52 includes a curved part 56 that is curved spherically protruding toward the light guide plate 19. This makes it possible to emit the light from the light guide lens 52 after refracting the light in a direction away from the center at a boundary with the external air layer, i.e., in a wide angle. With this structure, the light emitted from the LED 17 is refracted between the air layer and the incidence concave part 54, the concave part 55 and the air layer, and the curved part 56 and the air layer, and therefore the light is directed outward from the center of the light guide lens 52.

FIG. 11 is a graph of brightness distribution of the light emitted from the curved part 56 and the concave part 55 of the light guide lens 52. In the figure, a relative position of 0° corresponds to the central part of the light guide lens 52 (central part of the concave part 55), and the brightness distribution ranges from the central part of the light guide lens 52 to the outer periphery; degrees of 90° and −90° correspond to the outer periphery of the light guide lens 52 (curved part 56). As illustrated in FIG. 9, the light emitted from the central part of the light guide lens 52 (straightly upward from the LED 17, a relative position of 0°) has lower brightness than that from the periphery. Then, the brightness increases from the central part of the light guide lens 52 toward the outer periphery thereof, and reaches maximum at relative positions of 60° and −60° and then decreases toward the outer edges (relative positions of 90° and) −90°. Thus, the light emitted from the LED 17 and passed through the light guide lens 52 is directed not toward the part right above the LED 17 (part 19b1 of the light incidence surface 19b of the light guide plate 19 that faces the LED 17) but toward the peripheral part (part 19b2 of the light incidence surface 19b of the light guide plate 19 that does not face the LED 17). In this case, the part 19b1 of the light incidence surface 19b of the light guide plate 19 receives a small amount of light and the part 19b2 of the light incidence surface 19b of the light guide plate 19 that does not face the LED 17 receives a large amount of light.

The LED board 32 is fixed to the bottom plate 14a of the chassis 14 with a rivet 57 as illustrated in FIG. 9. The rivet 57 includes a disk-like pressing part 57a and a locking part 57b protruding downward from the pressing part 57a. The LED board 32 has an insertion hole 32c for having the locking part 57b inserted therethrough, and the bottom plate 14a of the chassis 14 has an attachment hole 14d that connects to the insertion hole 32c. An distal end of the locking part 57b of the rivet 57 is an elastically deformable wide part, and can be locked on a rear side of the bottom plate 14a of the chassis 14 through the insertion hole 32c and the attachment hole 14d. Thus, the rivet 57 can press the LED board 32 with the pressing part 57a, and therefore the LED board 32 is fixed to the bottom plate 14a.

On the other hand, on the bottom plate 14a of the chassis 14, a third reflection sheet (third reflection member) 58 is disposed to face the light incidence surface 19b of the light guide plate 19. The third reflection sheet 58 is made of a synthetic resin and its surface is white with high light reflection property. A hole part 58a is provided at a position of the third reflection sheet 58 that corresponds to the light guide lens 52. Therefore, the entire bottom plate 14a of the chassis 14 and the LED board 32 are covered with the third reflection sheet 58. However, the light guide lens 52 is exposed to the light guide plate 19 side through the hole part 58a. This third reflection sheet 58 allows the light emitted from the LED 17 to be reflected toward the light guide plate 19.

As thus described, in this embodiment, the light guide lens 52 has the concave part 55 that is depressed toward the LED 17 in the part that faces the light incidence surface 19b and that overlaps with the LED 17 in a plan view, and the concave part 55 refracts and emits the light from the LED 17 outward from the center of the depression. In this structure, the optical path of the light emitted from the LED 17 is altered by the concave part 55 and the light travels not straightly upward from the LED 17 but to spread around the LED 17. Therefore, the light emitted from the LED 17 can be directed toward the part 19b2 of the light incidence surface 19b of the light guide plate 19 that does not face the front of the light source. As a result, the part 19b2 of the light incidence surface 19b that does not face the front of the LED 17 can also receive a sufficient amount of light and the formation of a dark spot on the part 19b2 can be suppressed.

The light guide lens 52 has, in the part that faces the LED 17, the incidence concave part 54 which is depressed in the light guide plate 19 and which refracts the light coming from the LED 17 outward from the center of the depression. Thus, the incidence concave part 54 makes it possible to propagate the light coming from the LED 17 more widely around the LED 17 and to increase the directivity of the emission light toward the part 19b2 of the light incidence surface 19b of the light guide plate 19 that does not face the front of the LED 17.

The light guide lens 52 has, around the concave part 55 in the part of the light guide lens 52 that faces the light incidence surface 19b of the light guide plate 19, the curved part 56 curved in an arc-like manner. In this case, the emission light can travel in a wide range in accordance with the curved shape of the curved part 56. As a result, light can be delivered to the entire light incidence surface 19b of the light guide plate 19 and the formation of a dark spot on the light incidence surface 19b can be suppressed further.

Moreover, the backlight unit 12 according to this embodiment includes the chassis 14 housing the LED 17 and the light guide lens 52, and the third reflection sheet 58 that faces the light incidence part is disposed on the surface of the chassis 14 that includes the LED 17. Accordingly, the light emitted from the LED 17 or the light reflected on the peripheral member such as the light guide plate 19 can be guided to the light guide plate 19 by reflection on the third reflection sheet 58. This allows efficient use of the light from the LED 17, thereby achieving higher brightness or reduction in number of the LEDs 17.

### Modified Example of Second Embodiment

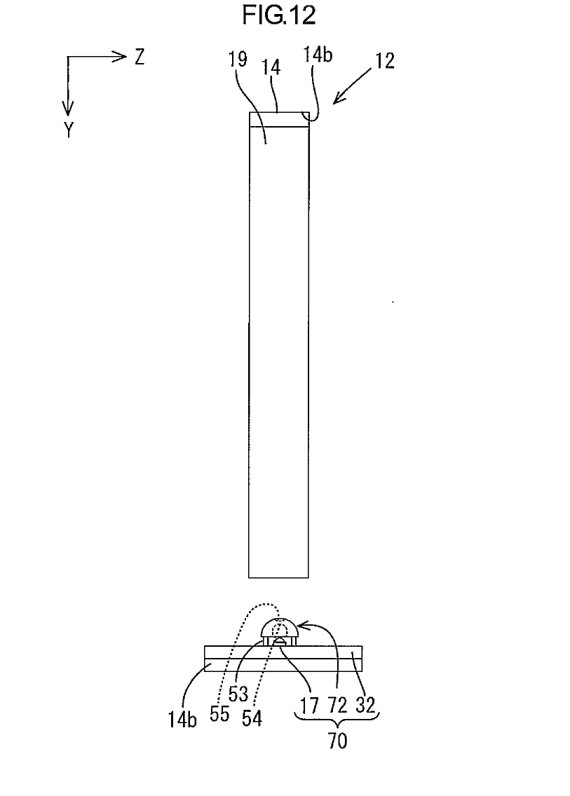

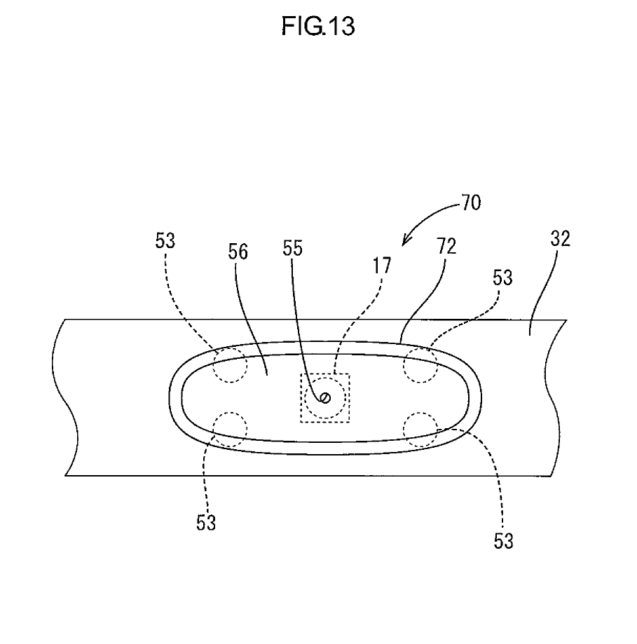

As a modified example of the structure of the LED unit 50, the example illustrated in FIG. 12 and FIG. 13 can be employed. FIG. 12 is a schematic side view of a different structure of the backlight unit, and FIG. 13 is a top view of an LED unit included in the backlight unit of FIG. 12.

An LED unit 70 has a structure similar to that of the second embodiment when seen in the X-Y plan view though not illustrated. Meanwhile, as illustrated in FIG. 12, in the Y-Z plan view, alight guide lens 72 has a hemispherical surface (semicircular section) curved to protrude upward (toward the light incidence surface 19b of the light guide plate 19). Moreover, as illustrated in FIG. 13, in the X-Z direction, the light guide lens 72 has a substantially elliptical shape whose major axis is in the X-axis direction and minor axis is in the Z-axis direction. Even in this structure, in a manner similar to the second embodiment, the optical path of the light emitted from the LED 17 is altered by the concave part 55, and therefore the light travels not straightly upward from the LED 17 but to spread around the LED 17 in the X-Y plan view. Therefore, the light emitted from the LED 17 can be directed toward the part 19b2 of the light incidence surface 19b of the light guide plate 19 that does not face the front of the light source. Further, since the light guide lens 72 has a hemispherical section curved protruding upward (toward the light incidence surface 19b of the light guide plate 19) in the Y-Z plan view, the light emitted from the LED 17 is refracted according to the shape of the curved surface and converged on the central part side of the light incidence surface 19b of the light guide plate 19 in the width direction (Z-axis direction). In other words, the light emitted from the LED 17 is difficult to travel in other directions than the direction toward the light incidence surface 19b. Therefore, the light emitted from the LED 17 can be guided to the light guide plate 19 efficiently, resulting in that higher brightness or reduction in number of the LEDs 17 can be achieved.

### Third Embodiment

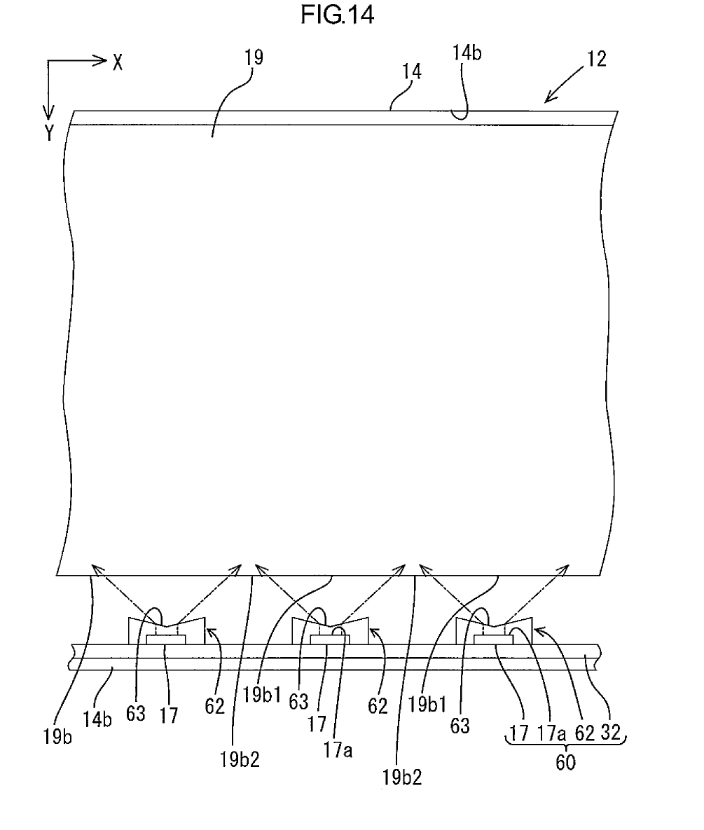

Next, the third embodiment of the present invention is described with reference to FIG. 14. The third embodiment employs the LED unit with a modified structure. The same part as that in the embodiments above is denoted with the same reference symbol and description thereof is omitted.

FIG. 14 is a schematic plan view of a structure of a backlight unit according to this embodiment.

An LED unit 60 includes the LED 17 and a light guide body (optical path altering member) 62 disposed covering the LED 17 as illustrated in FIG. 14. The light guide body 62 is made of a synthetic resin material (such as acrylic) with a higher refractive index than that of the air. This light guide body 62 does not have a space from the LED 17 and is integrated with the LED 17, differently from the second embodiment. An upper surface of the light guide body 62 has a concave part 63 entirely depressed downward (toward the LED 17). That is, the concave part 63 is in a substantially inverted-conical form and has an opening opened to a front side (toward the light guide plate 19). An end of the opening of the concave part 63 that faces the light guide plate 19 has the largest diameter, which is larger than the diameter of the LED 17. The concave part 63 has an inclined surface that intersects with the emission optical axis (Y-axis direction) of the LED 17, and the diameter gradually decreases toward the rear side and the end on the rear side (central part of the concave part 63) has a sharp angle. This concave part 63 has a function of refracting and emitting the light, which enters the light guide body 62 in the Y-axis direction from the LED 17, outward from the center of the depression with the inclined surface.

With this structure, the light emitted from the LED 17 is emitted outward from the center of the concave part 63 of the light guide body 62, i.e., in a wide angle around the LED 17. As a result, light reaches the part 19b2 of the light incidence surface 19b of the light guide plate 19 that does not face the LED 17, and the formation of a dark spot on the part 19b2 can be suppressed.

### Fourth Embodiment

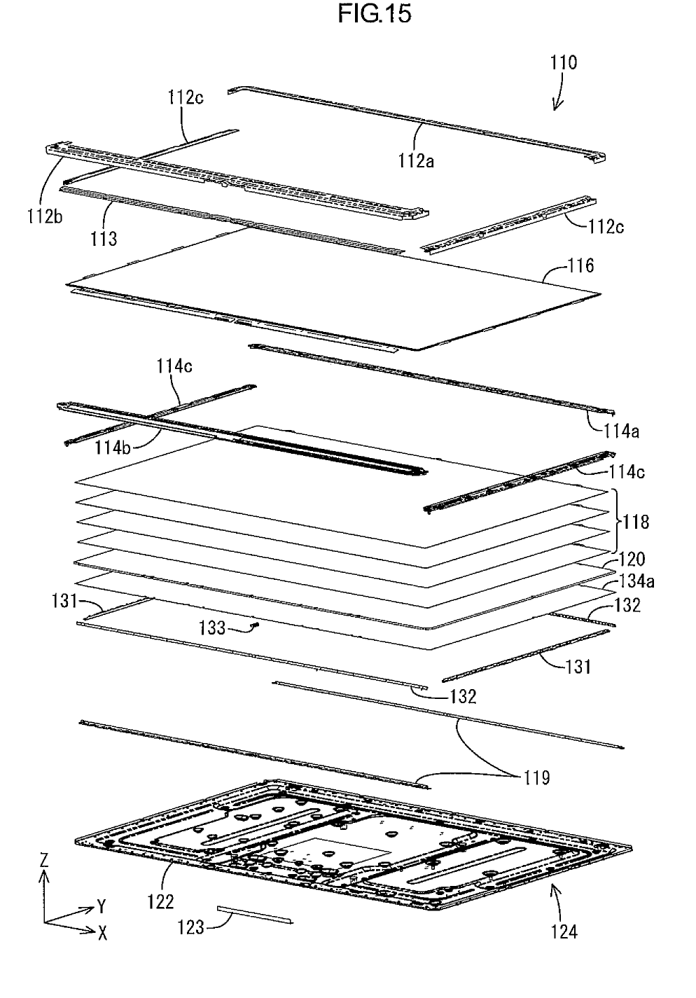

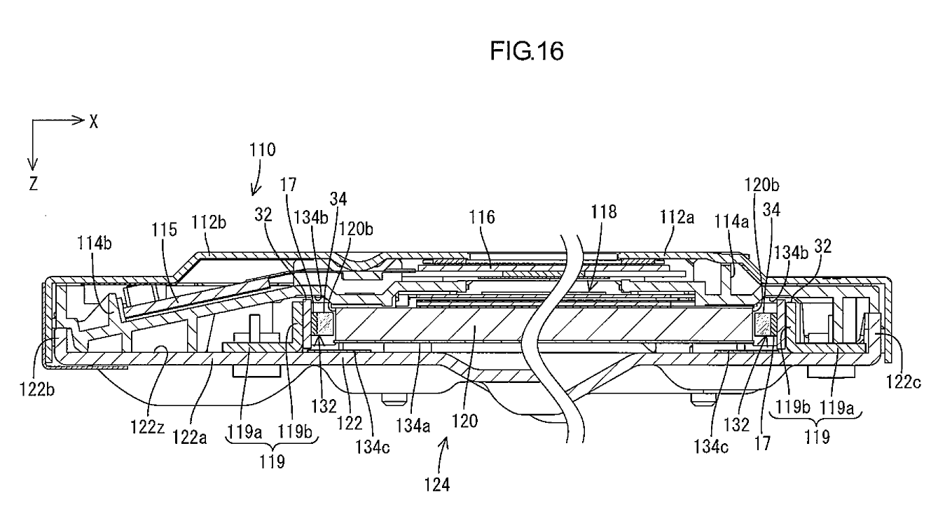

Next, a fourth embodiment of the present invention is described with reference to FIG. 15 and FIG. 16. The fourth embodiment employs the liquid crystal display device with a modified structure. The same part as that in the first embodiment above is denoted with the same reference symbol and description thereof is omitted.

FIG. 15 is an exploded perspective view of a schematic structure of the liquid crystal display device according to this embodiment, and FIG. 16 is a sectional view of a structure of the liquid crystal display device of FIG. 15. Note that the upper side of FIG. 15 and FIG. 16 is the front side, and the lower side thereof is the rear side.

A liquid crystal display device 110 has a horizontally long rectangular shape as a whole, and includes a liquid crystal panel 116 as a display panel, and a backlight unit 124 as an external light source as illustrated in FIG. 15. These are integrally held by a top bezel 112a, a bottom bezel 112b, a side bezel 112c (hereinafter referred to as a bezel group 112a to 112c), and the like. Since the liquid crystal panel 116 has a similar structure to that of the first embodiment, the description is not made.

The backlight unit 124 is described below. As illustrated in FIG. 15, the backlight unit 124 includes a backlight chassis (holding member, supporting member) 122, an optical member 118, a top frame (holding member) 114a, a bottom frame (holding member) 114b, a side frame (holding member) 114c (hereinafter referred to as a frame group 114a to 114c), and a reflection sheet 134a. The liquid crystal panel 116 is held by the bezel group 112a to 112c and the frame group 114a to 114c. Note that reference symbol 113 denotes an insulation sheet insulating a driving circuit board 115 (see FIG. 16) driving the liquid crystal panel. The chassis 122 has a substantially box-like shape with a bottom surface which has an opening opened to the front side (toward the light emission side and the liquid crystal panel 116 side). The optical member 118 is disposed on the front side of a light guide plate 120. The reflection sheet 134a is disposed on the rear side of the light guide plate 120. Moreover, a pair of cable holders 131, a pair of heat dissipation plates (attachment heat dissipation plate) 119, a pair of LED units 132, and the light guide plate 120 are housed in the chassis 122. The LED units 132, the light guide plate 120, and the reflection sheet 134a are mutually supported by a rubber bush 133. A power supply circuit board (not illustrated) supplying power to the LED unit 132, a protective cover 123 protecting the power supply circuit board, and the like are attached to the rear side of the chassis 122. The pair of cable holders 131 is disposed in a short-side direction of the chassis 122, and houses a wiring that electrically connects the LED unit 132 and the power supply circuit board to each other.

The chassis 122 includes a bottom plate 122a including a bottom surface 122z, and side plates 122b and 122c shallowly rising from the outer periphery of the bottom plate 122a, and supports at least the LED units 132 and the light guide plate 120 as illustrated in FIG. 16. The pair of heat dissipation plates 119 has a horizontal section like a letter of L including a bottom plane part 119a and a side plane part 119b rising from one outer periphery on a long side of the bottom plane part 119a. The heat dissipation plates 119 are disposed along the both long sides of the chassis 122. The bottom plane part 119a of the heat dissipation plate 119 is fixed to the bottom plate 122a of the chassis 122. The pair of LED units 132 extends along the both long sides of the chassis 122, and is fixed to the side plane part 119b of the heat dissipation plate 119 such that their light emission sides face each other. Therefore, the pair of LED units 132 is supported at the bottom plate 122a of the chassis 122 via the heat dissipation plate 119. The heat dissipation plate 119 releases the heat generated in the LED unit 132 to the outside of the backlight unit 124 via the bottom plate 122a of the chassis 122.

As illustrated in FIG. 16, the light guide plate 120 is disposed between the pair of LED units 132. Each longitudinal side face of the light guide plate 120 (side plane that faces the LED unit 132) serves as a light incidence surface 120b that receives the light from the LED 17. The pair of LED units 132, the light guide plate 120, and the optical member 118 are held between the frame group 114a to 114c and the chassis 122. Moreover, the light guide plate 120 and the optical member 118 are fixed by the frame group 114a to 114c and the chassis 122. Note that the structure of the LED unit 132, the structure of the light guide plate 120, and the structure of the optical member 118 are not described because they are similar to those of the first embodiment. The LED unit 132 has a structure similar to the structure including the LED 17, the LED board 32, and the light guide body 34 covering the LED 17 in the first embodiment. The backlight unit 124 in this embodiment employs a so-referred to as edge light type (side light type) but has a structure different from that of the first embodiment in that the LED unit 132 is disposed at both side ends of the light guide plate 120.

A driving circuit board 115 is disposed on the front side of the bottom frame 114b. The driving circuit board 115 is electrically connected to the liquid crystal panel 116 and supplies image data or various control signals necessary for image display to the liquid crystal panel 116. On apart of the surface of the top frame 114a that is exposed to the LED unit 132, a front-side reflection sheet 134b is disposed along the long side of the light guide plate 120. Also, on a part of a surface of the bottom frame 114b that faces the LED unit 132, a front-side reflection sheet 134b is disposed along the long side of the light guide plate 120.

In the backlight unit 124 of this embodiment, the LED unit 132 also includes the LED 17, the LED board 32, and the light guide body 34 covering the LED 17. Therefore, a sufficient amount of light enters the entire light incidence surface 120b of the light guide plate 120 and the formation of a dark spot on the light incidence surface 120b can be suppressed. Further, in this embodiment, the pair of LED units 132 extends along the both long sides of the chassis 122 and the light guide plate 120 is disposed between the pair of LED units 132. Therefore, the light of the LED units 132 enter through the two light incidence surfaces 120b of the light guide plate 120, and therefore the brightness of the light guide plate 120 can be improved as a whole. Moreover, the formation of a dark spot can be further suppressed.

### Other Embodiment

Although the embodiments of the invention have been described, the present invention is not limited to the above embodiments explained in the above description and the drawings. For example, embodiments as below are also included in the technical range of the present invention.

(1) Although the first embodiment employs the structure in which the light guide body has a substantially right triangular section, another shape may be employed as long as a reflection part provided intersecting with the light emission surface of the LED and an light exiting part through which the light reflected on the reflection part exits are included.

(2) Although the first embodiment employs the structure in which the light guide body and the LED are in contact with each other, there may be a space between the light guide body and the LED.

(3) Although the first embodiment to the third embodiment employ the structure in which the LED unit is disposed only on one longitudinal edge part of the chassis, the LED unit may be disposed on the both longitudinal edge parts of the chassis. Alternatively, the LED unit may be disposed on the latitude edge part of the chassis.

(4) Although each of the above embodiments employs the structure in which the space is formed between the light guide body or the light guide lens and the light guide plate, the light guide body or the light guide lens may be in contact with the light guide plate. In this case, since the distance between the light guide body or the light guide lens and the light guide plate can be held uniform, the optical design is easy.

(5) Although each of the above embodiments employs the structure in which the LED light source emitting white light is mounted, for example, three kinds of red, green, and blue LED light sources may be surface-mounted or a blue LED light source may be combined with a yellow phosphor.

(6) Although each of the above embodiments employs the structure in which one light guide body or light guide lens covers one LED, one light guide body or light guide lens may cover a plurality of LED light sources.

(7) Although each of the above embodiments employs the structure in which the LED is used as the light source, a light source other than the LED may be used.

(8) Although each of the above embodiments employs the structure in which the diffuser plate used as the optical sheet group is combined with the diffuser sheet, the lens sheet, or the reflection type polarizing sheet, for example, two diffuser plates may be stacked to be used as the optical sheet.

(9) Although each of the above embodiments employs the liquid crystal display device in which the liquid crystal panel is used as the display panel, the present invention is also applicable to a display device including another kind of display panel.

### EXPLANATION OF SYMBOLS

10: Liquid crystal display device (Display device)
11, 116: Liquid crystal panel (Display panel)
12, 124: Backlight unit (Lighting device)
14, 122: Chassis
17: LED (Light source)
19, 120: Light guide plate
19b, 120b: Light incidence surface of light guide plate
19b2: Part of light incidence surface of light guide plate that does not face front of light source
32: LED board (Light source board)
34, 62: Light guide body (Optical path altering member)
34b: Leg part of light guide body
34c: Hypotenuse part of light guide body
35: Reflection part
36: Light exiting part
37: First reflection sheet (First reflection member)
38: Second reflection sheet (Second reflection member)
52: Light guide lens (Optical path altering member)
54: Incidence concave part
55, 63: Concave part
56: Curved part
TV: Television receiver

1. A lighting device comprising:
a light source having an emission surface;
a light guide plate having a light incidence surface on a side face thereof, the light incidence surface through which light emitted from the light source enters, the light guide plate being configured to guide the light entered therein; and
an optical path altering member arranged so as to cover the light emission surface of the light source, the optical path altering member being configured to alter an optical path of the light emitted from the light source, wherein:
the light source is arranged so as to face the light incidence surface of the light guide plate with the optical path altering member therebetween; and
the optical path altering member reflects or refracts the light emitted from the light source such that the light travels toward a part of the light incidence surface that does not directly face the light source.

2. The lighting device according to claim 1, wherein the optical path altering member includes a reflection part and a light exiting part, the reflection part being arranged to intersect with an imaginary extended surface of the light emission surface of the light source and configured to reflect the light from the light source, the light exiting part through which the light reflected by the reflection part exits.

3. The lighting device according to claim 2, wherein the light exiting part is arranged so as to be substantially perpendicular to the light incidence surface of the light guide plate.

4. The lighting device according to claim 2, wherein:
the light source comprises a plurality of light sources; and
the optical path altering member arranged so as to cover the light emission surface of one of the light sources has the light exiting part that faces toward adjacent one of the light sources.

5. The lighting device according to claim 2, wherein:
the light source comprises a plurality of light sources; and
the optical path altering member for one of the light sources includes the reflection part arranged closer to adjacent one of the light sources and the light exiting part arranged closer to adjacent another one of the light sources.

6. The lighting device according to claim 2, wherein the optical path altering member has three surfaces arranged so as to define a substantially right triangle including a hypotenuse and a leg portion, the leg portion extending from the light source toward the light guide plate;
one of the three surfaces that includes the hypotenuse part is the reflection part and another one of the three surfaces that includes the leg part is the light exiting part.

7. The lighting device according to claim 2, further comprising a first reflection member arranged on a surface of the reflection part that is opposite to a surface of the reflection part facing the light source.

8. The lighting device according to claim 1, wherein:
the optical path altering member has a concave part depressed toward the light source, the concave part being provided at a part of the optical path altering member that faces the light incidence surface and that overlaps with the light source in a plan view; and
the concave part is configured such that the light from the light source exits outward from a center of the concave part after being refracted.

9. The lighting device according to claim 8, wherein:
the optical path altering member has a light incidence part depressed toward the light guide plate, the light incidence part being provided at a part of the optical path altering member that faces the light source,
the light incidence part is configured such that the light from the light source is refracted outward from the center of the depression.

10. The lighting device according to claim 8, wherein the optical path altering member has a curved part curved in an arc-like manner, the curved part being arranged around the concave part in the part of the optical path altering member that faces the light incidence surface.

11. The lighting device according to claim 1, wherein:
the light source comprises a plurality of light sources and the optical path altering member comprises a plurality of optical path altering members; and
each of the optical path altering members covers each of the light sources.

12. The lighting device according to claim 1, further comprising:
a light source board on which the light source is mounted; and
a second reflection member facing the light incidence surface of the light guide plate, the light reflection member being arranged on a surface of the light source board on which the light source is mounted.

13. The lighting device according to claim 1, further comprising:
a chassis housing the light source and the optical path altering member; and
a third reflection member facing the light incidence surface of the light guide plate, the third reflection member being arranged on a surface of the chassis on which the light source is mounted.

14. The lighting device according to claim 1, wherein the light source is an LED.

15. A display device comprising:
the lighting device according to claim 1; and
a display panel configured to provide display using light from the lighting device.

16. The display device according to claim 15, wherein the display panel is a liquid crystal panel using liquid crystals.

17. A television receiver comprising the display device according to claim 15.
